(19) United States
(12) Patent Application Publication
(10) Pub. No.: US 2023/0025347 A1
(43) Pub. Date: Jan. 26, 2023

(54) GRAPHICS FUSION TECHNOLOGY SCENE DETECTION AND RESOLUTION CONTROLLER

(71) Applicant: MediaTek Inc., Hsin-Chu (TW)

(72) Inventors: Jen-Jung Cheng, Hsinchu City (TW); Shih-Chin Lin, Hsinchu City (TW); Du-Xiu Li, Hsinchu City (TW); Ying-Chieh Chen, Hsinchu City (TW); Kun-Han Huang, Hsinchu City (TW)

(73) Assignee: MediaTek Inc., Hsin-Chu (TW)

(21) Appl. No.: 17/849,473

(22) Filed: Jun. 24, 2022

Related U.S. Application Data
(60) Provisional application No. 63/223,080, filed on Jul. 19, 2021.

(51) Int. Cl. G06T 7/00; G06T 3/40; G06V 10/74

(52) U.S. Cl. CPC G06T 7/0002; G06T 3/40; G06V 10/74; G06T 2207/30168

(57) ABSTRACT

Disclosed are embodiments of a graphics scene detection technique that provides an adaptive scale factor dependent on an image quality, such that certain images may be downscaled prior to being displayed to preserve system resources without significantly affecting image quality for a user. The inventors recognized and appreciated that certain images may be presented at a lower resolution to a user without being perceived as lower image quality. Some aspects provide a scene detection module that determines a quality score from a graphic command output for an image. Depending on the quality score, the scene detection module may output a quality-aware scale factor that can be applied to reduce pixel resolution of an image before displaying the image to a user. Resultingly, the computing device may be improved by saving system resources including memory bandwidth, processing power for other apps or instances, without negatively affecting visual perception of the scene.

### CROSS-REFERENCE TO RELATED APPLICATIONS

This application claims the benefit under 35 U.S.C. 119(e) of U.S. Provisional Application Ser. No. 63/223,080, filed Jul. 19, 2021, entitled “GRAPHICS FUSION TECHNOLOGY SCENE DETECTION AND RESOLUTION CONTROLLER,” which is hereby incorporated herein by reference in its entirety.

### BACKGROUND

The present application relates generally to systems and methods for displaying graphics in a computing device, and in particular, to systems and methods for displaying graphics in a portable or mobile device.

Modern mobile devices such as smart phones, tablet computers or other handheld or wearable computing devices provide their human users a variety of functionality such as communication, productivity, and entertainment, enabled in part by software including a mobile device's operating system and numerous available mobile applications (“apps”) that can be installed on top of the operating system. Some mobile devices are equipped with a large, high resolution, high refresh rate display that can provide a user an enhanced visual experience, for example when playing mobile gaming apps on the mobile devices.

### SUMMARY

Some embodiments are directed to a method for displaying a series of images by a computing device that comprises a graphic command module and a scene detection module. The method comprises receiving, by the scene detection module, a first graphic command output representing a first image from the graphic command module; and determining, by the scene detection module, a quality score of the first image based on the first graphic command output and a scale factor based on the quality score.

Some embodiments are directed to a computing device comprising a graphic command module configured to provide a graphic command output; a scene detection module coupled to the graphic command module and configured to: receive a first graphic command output representing a first image from the graphic command module; and determine a quality score of the first image based on the first graphic command output and a scale factor based on the quality score.

Some embodiments are directed to an apparatus comprising at least one display interface; at least one computer-readable storage device having stored thereon executable instructions; and at least one processor programmed by the executable instructions to perform a method comprising acts of: receiving a first graphic command output configured to cause a first image to be displayed by the at least one display interface; determining a quality score of the first image based on the first graphic command output and a scale factor based on the quality score.

### BRIEF DESCRIPTION OF DRAWINGS

Various aspects and embodiments will be described with reference to the following figures. It should be appreciated that the figures are not necessarily drawn to scale. In the drawings, each identical or nearly identical component that is illustrated in various figures is represented by a like numeral. For purposes of clarity, not every component may be labeled in every drawing.

FIG. 1 is a high level block diagram showing an exemplary computing device in which some embodiments can be practiced;

FIG. 2 shows a schematic diagram illustrating an exemplary computing device with a scene detection module, according to some embodiments;

FIG. 3 shows a schematic diagram illustrating an exemplary process for applying the scale factor outputted by the scene detection module to a subsequent frame, in accordance with some embodiments;

FIG. 4 shows a schematic flow diagram illustrating an exemplary process for determining the quality score and the scale factor using a scene detection module, in accordance with some embodiments;

FIG. 5A shows a schematic flow diagram illustrating an exemplary process using a scene detection module to generate the quality score and the output scale factor, in accordance with some embodiments;

FIG. 5B shows a schematic flow diagram illustrating a second example using a scene detection module with a dynamic quality threshold, in accordance with some embodiments;

FIG. 5C shows a schematic flow diagram illustrating a third example using a scene detection module with a feedback loop for adjusting the scale factor, in accordance with some embodiments;

FIG. 6 shows a schematic flow diagram illustrating an exemplary process using a resolution controller to apply a scale factor to the graphic command output, in accordance with some embodiments;

FIG. 7 shows a schematic flow diagram illustrating an example outputting multiple scale factors, in accordance with some embodiments.

### DETAILED DESCRIPTION

Aspects of the present application relate to a graphics scene detection technique that provides an adaptive scale factor dependent on an image quality, such that certain images may be downscaled prior to being displayed to preserve system resources without significantly affecting image quality for a user.

Certain mobile apps such as mobile gaming apps command a significant amount of system resources such as graphics processing power, memory storage, and power consumption due in part to the amount of computation for rendering images each having a large number of pixels at high refresh rates for displaying to the user. This is particularly the case when an app is trying to maintain a high framerate per second (FPS) while displaying high resolution games using a large data bandwidth and computing power. When system resources become limited, a gaming app may no longer be able to sustain the FPS, leading to dropped frames, glitches, or other artifacts that may negatively impact a user's experience playing the mobile game.

The inventors have recognized and appreciated that certain images may be presented at a lower resolution to a user without being perceived as lower image quality. Some aspects of the present application provide a scene detection module in a computing device that determines a quality score from a graphic command output for an image. Depending on the quality score, the scene detection module may output a quality-aware scale factor that can be applied to reduce the pixel resolution of an image before displaying the image to a user. As a result, the computing device may be improved by saving system resources including memory bandwidth, processing power for other apps or instances, without negatively affecting a user's visual perception of the scene.

In some embodiments, the scene detection module may determine the quality score for an image using a perceptual image quality metric. A predetermined threshold may be provided such that when the quality score exceeds the threshold, it is deemed that the image has sufficiently high quality that displaying a downscaled version of the image with a lower pixel resolution may not be perceived as low quality to a user, and a scale factor for downscaling the image may be selected as a result. In some embodiments where a scale factor is already applied, an even lower, more aggressive scale factor may be selected by the scene detection module upon determination that the quality score exceeds the predetermined threshold to further reduce system resource consumption. The predetermined threshold need not be a constant value for all images and in some embodiments, the predetermined threshold may be dynamically adjusted based on one or more criteria during operation of the methods disclosed herein.

In some embodiments, the quality score may be determined by comparing an input image with a rescaled image. The rescaled image may be generated by first downscaling the input image by a scale factor to obtain an intermediate image. The intermediate image may have a lower pixel resolution than the input image. Subsequently, the intermediate image is upscaled to the same pixel resolution as the original input image and as the rescaled image. Because information in certain pixels are lost during the downscaling step to obtain the intermediate image, the rescaled image will demand less system resources for rendering compared to the original image. If the rescaled image is perceived as sufficiently close to the original input image such that the quality score exceeds the predetermined threshold, then the scene detection module may output the scale factor to apply further downscaling to the image. If the quality score does not exceed the threshold, the scene detection module may revert to a previous, less aggressive scale factor as output.

In some embodiments, the quality score may be determined by calculating a peak signal to noise ratio (PSNR) function between the input image and the rescaled version of the input image, although any suitable image quality metric may be used to determine the quality score.

Some aspects are directed to how the computing device utilizes the scale factor outputted by the scene detection module based on a first graphic command output to modify a second graphic command output. In some embodiments, a resolution controller is provided that receives the output scale factor from the scene detection module. The resolution controller may be coupled to a graphic command module that generates graphic command outputs. The resolution controller may supply additional commands to the graphic command module such that the second graphic command output is downscaled before being displayed to the user. In one example, the resolution controller may change a size of a framebuffer for a second image represented by the second graphic command output based on the scale factor.

The aspects and embodiments described above, as well as additional aspects and embodiments, are described further below. These aspects and/or embodiments may be used individually, all together, or in any combination of two or more, as the disclosure is not limited in this respect.

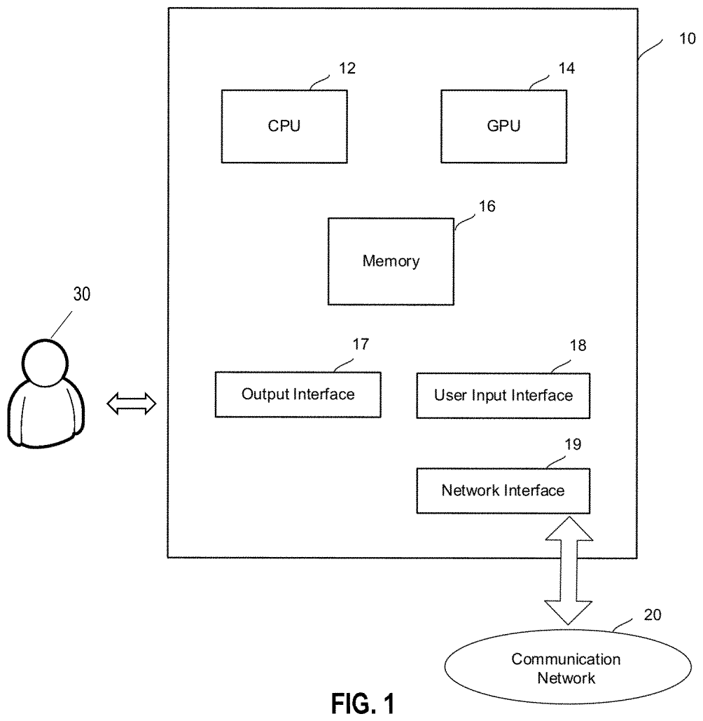

FIG. 1 is a high level block diagram showing an exemplary computing device in which some embodiments can be practiced. In FIG. 1, computing device 10 may be a portable, handheld, or wearable electronic device. Computing device 10 may in some embodiments be a smartphone, a personal digital assistance (PDA), tablet computer, a smartwatch. Computing device 10 may be powered by a battery such as a rechargeable battery. Computing device 10 may also be a general purpose computer, as aspects of the present application are not limited to a portable device or a battery-powered device.

Computing device 10 includes a central processing unit (CPU) 12 having one or more processors, a graphics processing unit (GPU) 14 having one or more graphics processors, and a non-transitory computer-readable storage medium 16 that may include, for example, volatile and/or non-volatile memory. The memory 16 may store one or more instructions to program the CPU 12 and/or GPU 14 to perform any of the functions described herein. The computing device 10 may have one or more input devices and/or output devices, such as user input interface 18 and output interface 17 as illustrated in FIG. 1. These devices can be used, among other things, to present a user interface. Examples of output interface that can be used to provide a user interface include printers or display screens for visual presentation of output, speakers or other sound generating devices for audible presentation of output, and vibratory or mechanical motion generators for presentation of tactile output. Examples of input interface that can be used for a user interface include keyboards and pointing devices, such as mice, touch pads, or digitizers for pen, stylus or finger touch input. As another example, the input interface 18 may include one or more microphones for capturing audio signals, one or more cameras and light sensors to capture visual signals, and the output interface 17 may include a display screen for visually rendering, and/or a speaker for audibly rendering, images or text to a user 30 of the computing device 10.

Also as shown in FIG. 1, the computing device 10 may comprise one or more network interfaces 19 to enable communication via various networks (e.g., the network 20). Examples of networks include a local area network or a wide area network, such as an enterprise network or the Internet. Such networks may be based on any suitable technology and may operate according to any suitable protocol and may include wireless networks, wired networks or fiber optic networks. Examples of network interfaces include Wi-Fi, WiMAX, 3G, 4G, 5G NR, white space, 802.11×, satellite, Bluetooth, near field communication (NFC), LTE, GSM/WCDMA/HSPA, CDMA 1×/EVDO, DSRC, GPS, etc.) While not shown, computing device 10 may additionally include one or more high speed data buses that interconnect the components as shown in FIG. 1, as well as a power subsystem that provide electric power to the components.

In some embodiments, computing device 10 may be a mobile device and the output interface 17 may include a high pixel resolution display. A pixel resolution may refer to pixel counts along both axis of a rectangular display surface e.g., a vertical axis and a horizontal an axis, or along a width and a height directions, or along a row and a column directions. The display may have a pixel resolution of 720p or 1,280×720, 1080p or 1,920×1,080, 2K or at least 2,048 pixels along one axis, UHD or 3,840×2,160, 4K or at least 4,096 pixels along one axis, 8K or at least 7,680 pixels along one axis, 10K or at least 10,240 pixels along one axis, or having higher or lower number of pixels along either axis than those enumerated. The display may support a frame rate, namely the frequency at which consecutive images or frames are displayed, of at least 24 FPS, at least 30 FPS, at least 48 FPS, at least 60 FPS, at least 120 FPS, at least 240 FPS, between 30 and 240 FPS, or any suitable frame rate.

Some embodiments as described below are directed to methods that can be executed by the CPU 12 and/or GPU 14 based on instructions that are stored on non-transitory storage medium 16. Such instructions may be software, program code, and firmware. Certain embodiments may be embodied in one or more modules. A module may be a software module embodied in instructions stored in a non-transitory machine-readable medium. A module may also alternatively or additionally be a hardware-implemented module, which is a tangible unit capable of performing certain operations and may be configured or arranged in a certain manner. In some embodiments, components within computing system 10 including one or more processors may be configured by software (e.g., an application or application portion) as a hardware-implemented module that operates to perform certain methods as described herein.

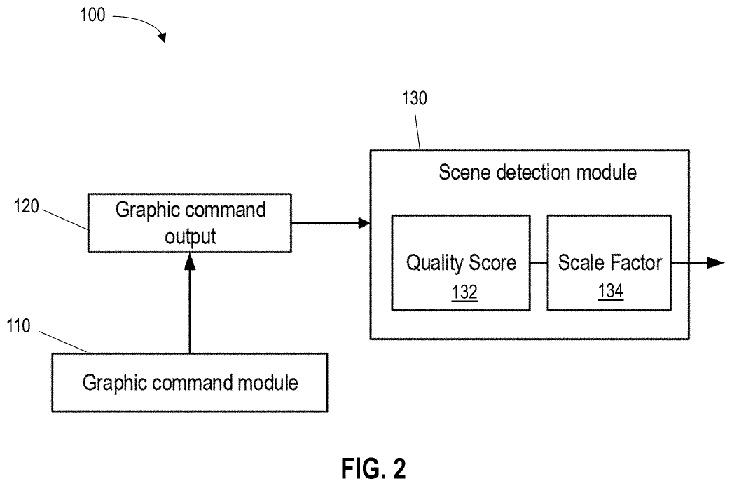

FIG. 2 shows a schematic diagram illustrating an exemplary computing device with a scene detection module, according to some embodiments. In FIG. 2, computing device 100 includes a graphic command module 110, which generates an output graphic command output 120 to represent a frame or an image for a scene. Graphic command output 120 may be in one of any number of suitable graphic command format for rendering of an image, such as but not limited to OpenGL, DirectX, or Vulkan. Graphic command output 120 may represent an input image, and is received by a scene detection module 130, which analyzes the input image based on the graphic command output 120 to determine a quality score 132 for the input image. Scene detection module 130 further determines and outputs a scale factor 134 based on the quality score. Scene detection module 130 may use any number of suitable image quality perception algorithms to determine quality score 132 for the input image based on the graphic command output 120. In some embodiments, if the quality score 132 is indicative of an image that can be further downscaled without affecting user perception, scale factor 134 may be selected to be lower than 1 for further downscaling. Further examples of the determination of the quality score and scale factor will be discussed below. In some embodiments, graphic command output 120 may already represent a rescaled image using a previous scale factor, and depending on the quality score 132, scene detection module 130 may determine that the output scale factor 134 may be lower than the previous scale factor, higher than the previous scale factor, or remain the same as the previous scale factor.

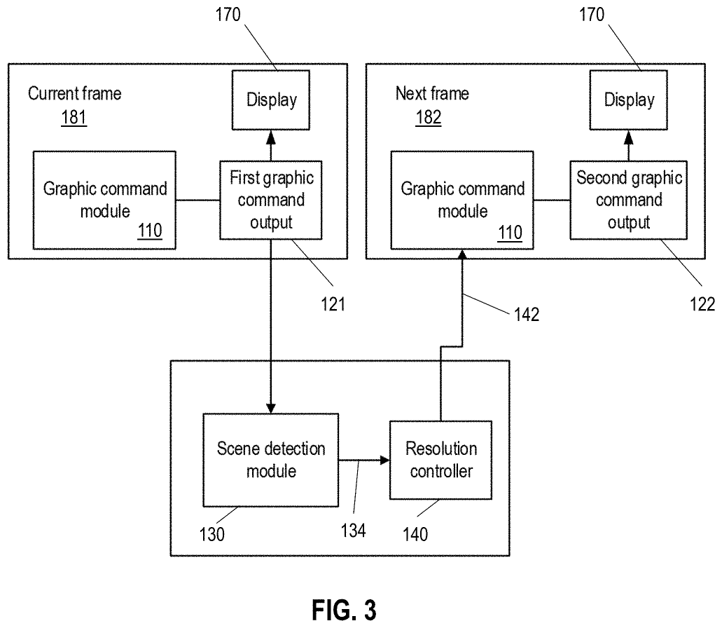

FIG. 3 shows a schematic diagram illustrating an exemplary process for applying the scale factor outputted by the scene detection module to a subsequent frame, in accordance with some embodiments. In FIG. 3, graphic command module 110 generates a first graphic command output 121 representing a first image or current frame 181, while the graphic command module 110 further generates a second graphic command output 122 representing a second, subsequent image or a next frame 182. Scene detection module 130 receives the first graphic command output 121 for the current frame 181, determines a quality score and outputs a scale factor 134. Graphic command module 110 then applies output scale factor 134 when generating the second graphic command output 122, such that a rescaled second image is rendered for the display 170. Any suitable protocol and hardware may be used to cause the rescaled second image to be displayed to a user by display 170. As a result of applying the scale factor, system resources may be saved during rendering of the second image 182.

Still referring to FIG. 3, a resolution controller 140 may be provided to receive the output scale factor 134, and to provide additional commands 142 to graphic command module 110 that causes graphic command module 110 to generate second graphic command output.

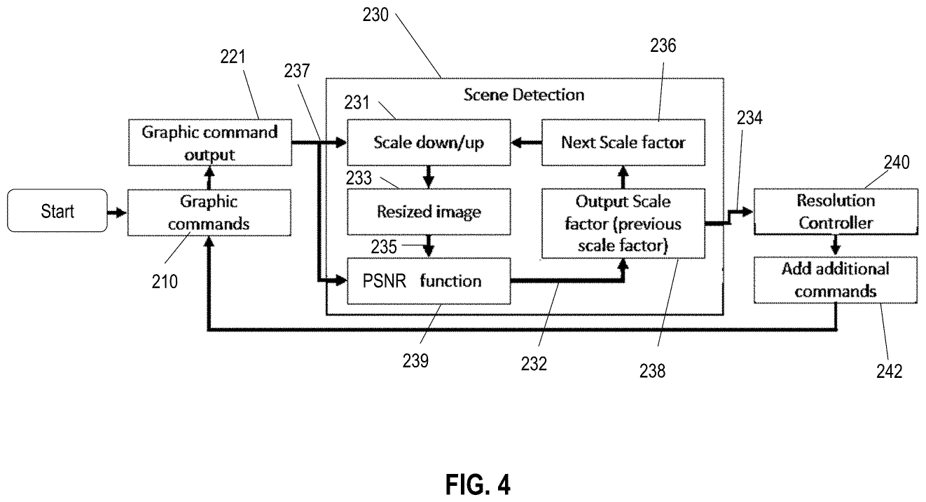

FIG. 4 shows a schematic flow diagram illustrating an exemplary process for determining the quality score and the scale factor using a scene detection module, in accordance with some embodiments.

FIG. 4 shows that at the start of the process, graphic command module 210 generates a graphic command output 221 representing an input image 237. Scene detection module 230 receives graphic command output 221, and at block 231, downscales the input image using next scale factor 236 to obtain an intermediate image. Still at block 231, the intermediate image is subsequently upscaled back to the same pixel resolution as the input image 237 as a resized image or rescaled image 233. At block 239, a PSNR function is calculated using the input image 237 and the rescaled input image 235 as parameters, although it should be appreciated that any function that can represent a perceptive image quality comparison between two images may be used in place of the PSNR function. The result of block 239 is a quality score 232, which is received at block 238, in which an output scale factor 234 is determined based on the quality score 232.

FIG. 4 also shows that resolution controller 240 receives the output scale factor 234 and provides additional commands 242 to graphic command module 210 to perform scaling of one or more subsequent images to the input image 237. As such, a loop path is formed that comprises the graphic command module 210, to the scene detection module 230, and the resolution controller 240, such that image quality from the output of the graphic command module 210 is assessed by the scene detection module 230, and the resulting scale factor is applied back to the graphic command module 210 via the resolution controller. As a result, scenes may be downscaled without affecting perceived image quality by the user, and system resources for rendering of such scenes may be saved.

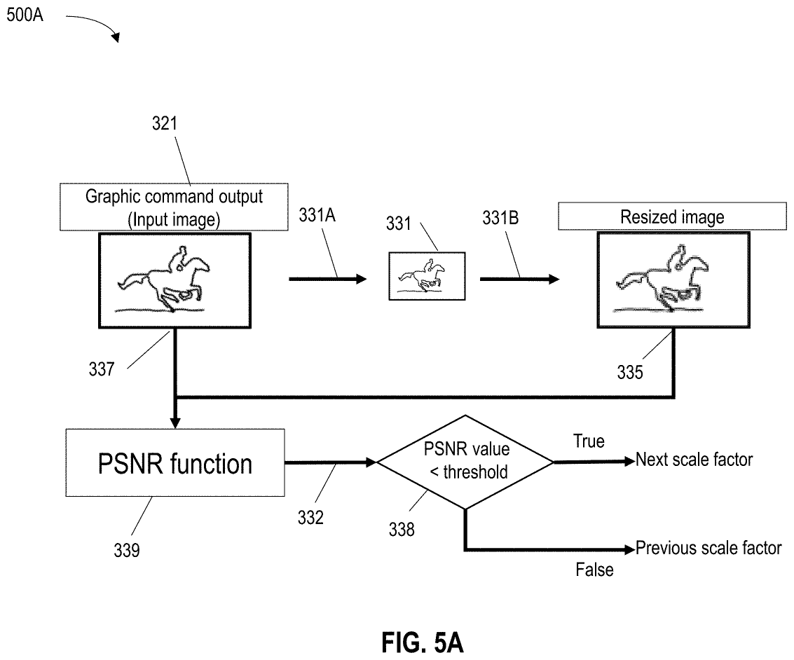

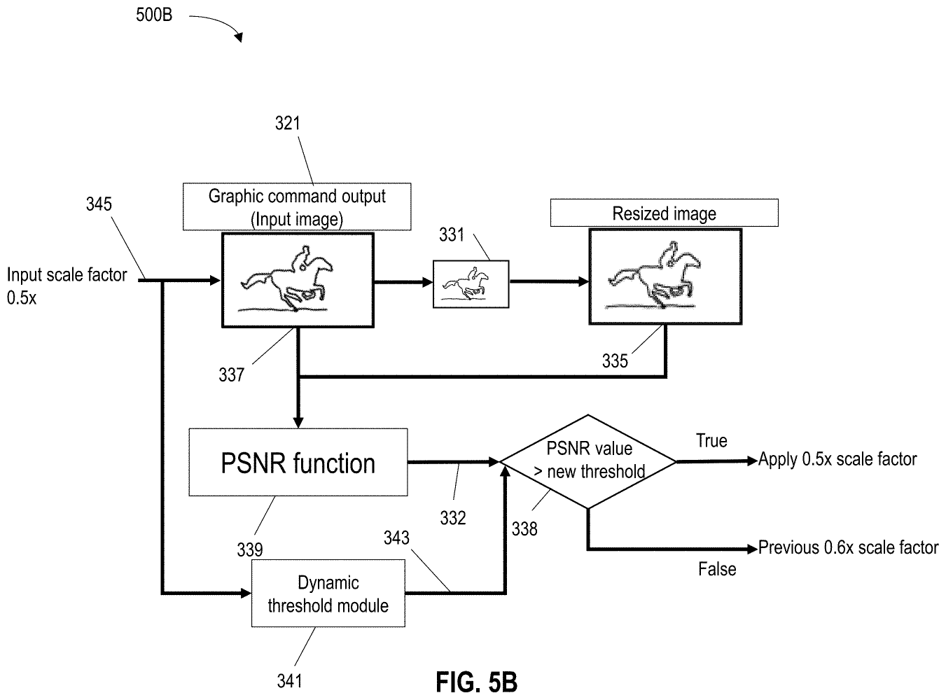

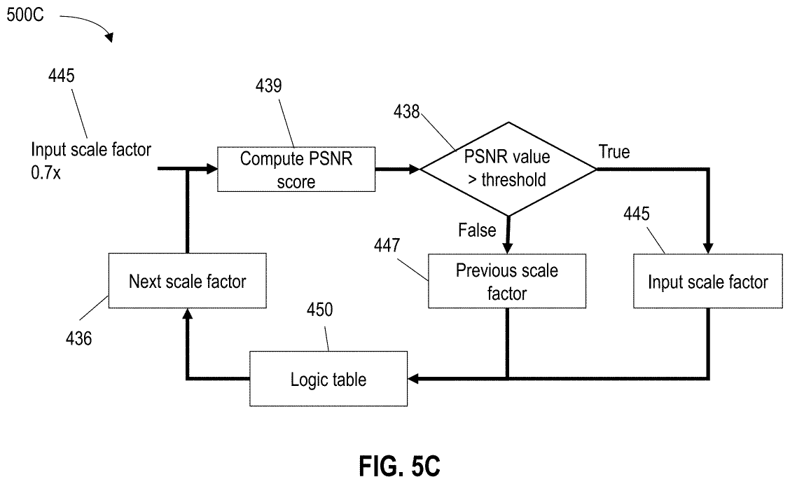

FIG. 5A shows a schematic flow diagram illustrating a first example using a scene detection module to generate the quality score and the output scale factor, in accordance with some embodiments.

In FIG. 5A, the process 500A begins with receiving a graphic command output 321 representing an input image 337. While not shown, any suitable commands or algorithm may be used to generate input image 337 from the graphic command output 321. In this non-limiting example, a next scale factor 236 having a value of 0.5× is used for illustrative purpose, and at act 331A, input image 337 is downscaled by 0.5× to arrive at an intermediate image 331 which has 0.5× the number of pixels in each axis compared to the input image. Therefore, intermediate image 331 requires less amount of memory and processing power to process. At act 331B, the intermediate image 331 is upscaled to become a resized image 335, using any suitable upscaling algorithm including but not limited to interpolation such as nearest-neighbor interpolation, bilinear interpolation, trilinear interpolation (mipmap), and Lanczos resampling, as well as Fast Fourier Transform (FFT)/Discrete Fourier Transform (DFT) based upscaling, machine learning or use of a resizer hardware accelerator. Because upscaling and downscaling are used to evaluate the loss of quality during downscaling operation of the image, in some embodiments the upscaling algorithm is implemented in a method that is similar to the actual upscaling algorithm of a GPU or resize hardware accelerator that are used to perform image processing.

The original input image 337 and the resized image 335 are compared using a PSNR function at act 339. The result of the PSNR function, or the PSNR value between input image 337 and resized image 335 is provided as a quality score 332. In general, a higher PSNR value relates to a better image quality. At block 338, the PSNR value is compared to a predetermined threshold to determine the output scale factor. In the example shown, if the PSNR value is greater than the threshold, the output scale factor is selected to be the next scale factor of 0.5× applied during the act of downscaling 331A, as the quality score appears to indicate that the scaled image will be acceptable to the user, and thus the next scale factor is acceptable. On the other hand, if the PSNR value is equal to or exceeds the threshold, the comparison result suggests that the resized image 335 after scaled by the next scale factor at step 331A is not acceptable. As a result, a different scale factor will be selected as output. As shown in the example in FIG. 5A, the selected different scale factor may be a previous scale factor, for example another scale factor previously used by the scene detection module that does not down scale the image as aggressively as the “next scale factor” applied during the act of downscaling 331A.

In some embodiments, the scene detection module keeps a list of previously used scale factors, for example 1×, 0.9×, 0.8×, 0.7×, 0.6×. When it is determined that a next scale factor of 0.5× does not provide a satisfactory quality score, the process 500A illustrated in FIG. 5A will revert to a previous scale factor 0.6× as output scale factor. In the next iteration of process 500A, if it is determined that a scale factor of 0.6× is too aggressive, process 500A will revert to a further previous scale factor of 0.7×, and so on and until a scale factor of 1× if necessary to maintain a satisfactory quality score.

Depending on the result of a comparison of the quality score with the predetermined threshold, the scene detection module may select an output scale factor in any one of a number of ways. In some embodiments, it is not necessary that the output scale factor is selected between two choices, and in some embodiments the output scale factor may be a function of the quality score. For example, a more aggressive scale factor may be selected for output if the quality score indicates a higher quality rescaled image compared to the original input image. It is also not necessary that an output scale factor be a downscaling scale factor. For example, sometimes it may be determined that no scale factor is to be applied at all, or namely, a scale factor of 1 is to be used to preserve perceived image quality by a user for some images.

The threshold value for comparison with the quality score at block 338 may be determined in a number of ways. For example, the threshold value may be pre-determined by calibrating with images of known precepted quality by an average user. The pre-determined threshold value may be stored in one of the memory 16 prior during manufacturing of the computing device. In other examples, the pre-determined threshold value needs not be a constant and may be updated after shipment of the computing device to a user, for example to accommodate the user's person preference.

FIG. 5B shows a schematic flow diagram illustrating a second example using a scene detection module with a dynamic quality threshold, in accordance with some embodiments.

In FIG. 5B, the process 500B is similar to the process 500A shown in FIG. 5A in many aspects, with like components illustrated with the same reference numbers. Process 500B differs from process 500A in that a dynamic threshold module 341 is provided that receives an input scale factor 345, and determines a threshold value 343 for use by block 338 in the comparison with the output of PSNR function. Input scale factor 345 may be the “next” scale factor determined by the output of a previous session of the scene detection module. Dynamic threshold module 341 may use any suitable command or algorithm to adjust the threshold 343 to provide different policies based on system information. In some embodiments, the threshold value may be adjusted based on the input scale factor. As one example of the algorithm that can be used by quality threshold module 341, threshold 343 may be equal to a ratio of a base threshold value over the input scale factor. When the input scale factor is 0.5× as shown in FIG. 5B, the threshold 343 may be 2× a base threshold value. For example, if the base threshold value is chosen to be 20 dB, then in FIG. 5B the threshold value 343 would be determined as 40 dB for use by block 338. At block 338, if the PSNR value is greater than the threshold value 343, the output scale factor is selected to be the next scale factor of 0.5×. If, on the other hand, the PSNR value is greater than the threshold value 343, the output scale factor is selected to be the previous scale factor of 0.6× in this example, so that a less aggressive scaling is applied.

FIG. 5C shows a schematic flow diagram illustrating a third example using a scene detection module with a feedback loop for adjusting the scale factor, in accordance with some embodiments.

In FIG. 5C, the process 500C begins with an input scale factor (445) of 0.7×, while a previous scale factor (447) is 0.8× at the beginning of the process. Initially, the PSNR value is determined at block 439 using the input scale factor 445 using any of the methods as described above by downscaling/upscaling an input image. The PSNR value is compared to a predetermined threshold at block 438. If the result of the comparison at block 438 is true, then it means the scaled image quality is acceptable (“accept”), and the input scale factor 445 is passed to a logic table 450 for determination of the next scale factor 436 as described below. If the result of the comparison at block 438 is false, namely the PSNR value is less than or equal to the threshold value 343, then it means the scaled image quality is unacceptable (“reject”). The next scale factor 436 is determined by using logic table 450 as shown in Table 1 below in each iteration of process 500C. The input of logic table 450 may be either input scale factor 445 or a previous scale factor 447, depending on the comparison result at block 438. With each iteration of process 500C, a value of next scale factor 436 may be used for computation of the PSNR score at block 439.

TABLE 1
Logic table for determining the next scale factor

| Previous iteration | Current iteration | |
|---|---|---|
| comparison result | comparison result | Next scale factor (step = 0.1×) |
| Don’t care | Accept | = input scale factor 0.7× − 0.1× |
| Accept | Reject | = previous scale factor 0.8× |
| Reject | Reject | = previous scale factor 0.8× + 0.1× |

As shown in Table 1, during each iteration the logic table 450 is invoked, the next scale factor may be adjusted in increments of 0.1× depending on the comparison result in block 438 of the current iteration, as well as the comparison result in block 438 in a previous iteration. If for example both the current comparison result and the previous iteration's comparison result are “reject,” the scale factor increases 0.1× such that a less aggressive downscaling is applied to the input image to preserve image quality. The feedback loop in process 500C may continue to iterate until finally the next scale factor reverts to 1.0×.

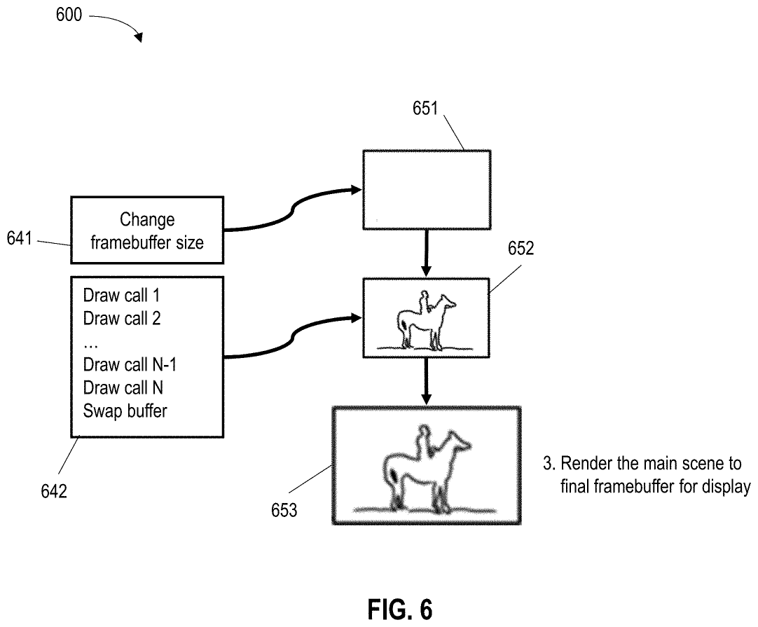

FIG. 6 shows a schematic flow diagram illustrating an exemplary process using a resolution controller to apply a scale factor to the graphic command output, in accordance with some embodiments. In FIG. 6, process 600 may be implemented by resolution controller 240 shown in FIG. 4, and at block 641, the resolution controller adds a command to graphic command module 210 to change a framebuffer size to a reduced framebuffer size 651. For example, if an output scale factor of 0.5× is received by the resolution controller 240, a framebuffer size can be reduced to ¼ that for the input image. At block 642, additional commands are sent from the resolution controller 240 to graphic command module 210 to render image 652 in the reduced framebuffer size. Subsequent to rendering the image 652, an upscaled image 653 is rendered to a size of a final framebuffer size for displaying to the user.

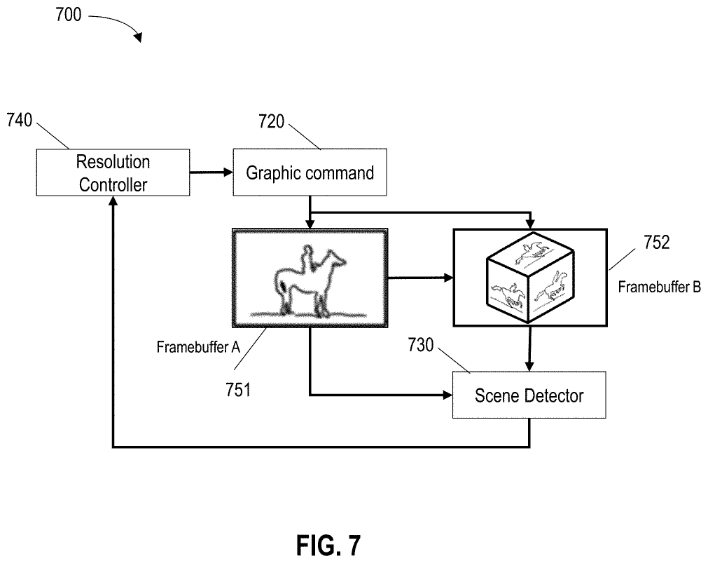

FIG. 7 shows a schematic flow diagram illustrating an example outputting multiple scale factors, in accordance with some embodiments. FIG. 7 illustrates a process 700 in which an application has two framebuffers 751, 752, and both framebuffers' input images are provided with their own scale factors. Initially, an input scale factor C=0.7× and scale factor D=0.8× are provided at the beginning of the process 700. Graphic command 720 then draws framebuffer A (751) with scale factor C, and uses framebuffer A as texture to draw framebuffer B (752) with scale factor D. Images in both framebuffers are evaluated in scene detector 730 using any of the methods described above, and scene detector 730 may in one exemplary scenario generate the following results: providing an adjusted scale factor C′=0.8× after scale factor C is rejected; providing an adjusted scale factor D′=0.7× after scale factor D is accepted, although other scenarios may also be possible. Scene detector 730 provides scale factors C′ and D′ to resolution controller 740 which applies the scale factors for displaying of the images in framebuffer A and framebuffer B, respectfully.

Having thus described several aspects of at least one embodiment of this invention, it is to be appreciated that various alterations, modifications, and improvements will readily occur to those skilled in the art.

Such alterations, modifications, and improvements are intended to be part of this disclosure and are intended to be within the scope of the invention. Further, though advantages of the present invention are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method for displaying a series of images by a computing device comprising a graphic command module and a scene detection module, the method comprising:
receiving, by the scene detection module, a first graphic command output representing a first image from the graphic command module; and
determining, by the scene detection module, a quality score of the first image based on the first graphic command output and a scale factor based on the quality score.

2. The method of claim 1, further comprising:
applying at least one scaling to a second graphic command output of the graphic command module representing a second image based on the scale factor.

3. The method of claim 1, wherein determining the quality score comprises:
comparing the first image with a rescaled first image.

4. The method of claim 3, wherein comparing the first image with a rescaled first image comprises:
downscaling the first image by a first scale factor to obtain a first intermediate image;
upscaling the first intermediate image to obtain the rescaled first image having a same pixel resolution as the first image; and
calculating the quality score by comparing the first image and the rescaled first image.

5. The method of claim 4, wherein calculating the quality score comprises:
calculating a peak signal to noise ratio (PSNR) between the first image and the rescaled first image.

6. The method of claim 4, wherein determining the scale factor based on the quality score comprises:
comparing the quality score with a predetermined threshold; and
setting the scale factor to be equal to the first scale factor or a value different from the first scale factor based on a result of comparing the quality score with the predetermined threshold.

7. The method of claim 2, wherein applying at least one scaling to the second graphic command output comprises:
downscaling the second graphic command output by the scale factor prior to displaying the second image.

8. The method of claim 7, wherein downscaling the second graphic command output comprises:
changing a size of a framebuffer for the second image based on the scale factor.

9. The method of claim 2, further comprising:
generating, by the graphic command module, the first graphic command output and the second graphic command output;
receiving, by a resolution controller, the scale factor from the scene detection module; and
providing, by the resolution controller, one or more commands to the graphic command module such that the at least one scaling is applied to the second graphic command output based on the scale factor.

10. A computing device, comprising:
a graphic command module configured to provide a graphic command output;
a scene detection module coupled to the graphic command module and configured to:
receive a first graphic command output representing a first image from the graphic command module; and
determine a quality score of the first image based on the first graphic command output and a scale factor based on the quality score.

11. The computing device of claim 10, wherein the scene detection module is further configured to:
downscale the first image by a first scale factor to obtain a first intermediate image;
upscale the first intermediate image to obtain a rescaled first image having a same pixel resolution as the first image; and
calculate the quality score by comparing the first image and the rescaled first image.

12. The computing device of claim 11, wherein the scene detection module is further configured to:
calculate the quality score by calculating a peak signal to noise ratio (PSNR) between the first image and the rescaled first image.

13. The computing device of claim 12, wherein the scene detection module is further configured to:
compare the quality score with a predetermined threshold; and
set the scale factor to be equal to the first scale factor or a value different from the first scale factor based on a result of a comparison between the quality score and the predetermined threshold.

14. The computing device of claim 10, further comprising:
a resolution controller coupled to the scene detection module and the graphic command module, and configured to:
receive the scale factor from the scene detection module; and
provide one or more commands to the graphic command module to apply a downscaling by the scale factor to a second graphic command output representing a second image.

15. The computing device of claim 14, wherein the at least one scaling comprises:
downscaling the second graphic command output by the scale factor prior to rendering the second image.

16. The computing device of claim 10, further comprising:
a display interface configured to display the first image based on the first graphic command output.

17. An apparatus, comprising:
at least one display interface;
at least one computer-readable storage device having stored thereon executable instructions; and
at least one processor programmed by the executable instructions to perform a method comprising acts of:
receiving a first graphic command output configured to cause a first image to be displayed by the at least one display interface;
determining a quality score of the first image based on the first graphic command output and a scale factor based on the quality score.

18. The apparatus of claim 17, further comprising:
applying at least one scaling based on the scale factor to a second graphic command output configured to cause a second image to be displayed by the at least one display interface.

19. The apparatus of claim 17, wherein the act of determining the quality score comprises:
downscaling the first image by a first scale factor to obtain a first intermediate image;
upscaling the first intermediate image to obtain the rescaled first image having a same pixel resolution as the first image; and
calculating the quality score by comparing the first image and the rescaled first image.

20. The apparatus of claim 19, wherein the act of calculating the quality score comprises:
calculating a peak signal to noise ratio (PSNR) between the first image and the rescaled first image.
